(19) United States
(12) Patent Application Publication
(10) Pub. No.: US 2019/0369426 A1
(43) Pub. Date: Dec. 5, 2019

(54) TOUCH LIQUID CRYSTAL DISPLAY PANEL, DISPLAY DEVICE AND TERMINAL

(71) Applicant: Wuhan China Star Oploelectronics Technology Co., Ltd., Wuhan (CN)

(72) Inventor: Zhihao CAO, Wuhan (CN)

(21) Appl. No.: 16/174,506

(22) Filed: Oct. 30, 2018

Related U.S. Application Data
(63) Continuation of application No. PCT/CN2018/104464, filed on Sep. 7, 2018.

(30) Foreign Application Priority Data
May 30, 2018 (CN) 201810541890.5

(51) Int. Cl. G02F 1/1339; G02F 1/1343; G02F 1/1333; G06F 3/041; G06F 3/044

(52) U.S. Cl. CPC G02F 1/1339; G02F 1/13394; G02F 1/134309; G02F 1/13338; G02F 2201/122; G06F 3/044; G02F 2001/13396; G02F 2201/121; G06F 3/0412

(57) ABSTRACT

The present invention discloses a touch liquid crystal display panel. The panel includes: a lower substrate, wherein an inner surface of the lower substrate is provided with a first and a second common electrode regions, and a spacer region located between the first and the second common electrode regions; a dielectric insulation layer covering on the first and the second common electrode regions and the entire spacer region; and an upper substrate opposite to the lower substrate, wherein an inner surface of the upper substrate is provided with a first and a second spacers, and the first spacer is pressed against the dielectric insulation layer corresponding to the first common electrode region and/or the second common electrode regions, and the second spacer is pressed against the dielectric insulation layer corresponding to the spacer region; wherein a height of the second spacer is greater than a height of the first spacer.

### CROSS-REFERENCE TO RELATED APPLICATION

This application is a continuing application of PCT Patent Application No. PCT/CN2018/104464, entitled “TOUCH LIQUID CRYSTAL DISPLAY PANEL, DISPLAY DEVICE AND TERMINAL”, filed on Sep. 7, 2018, which claims priority to China Patent Application No. 201810541890.5 filed on May 30, 2018, both of which are hereby incorporated in its entireties by reference.

### FIELD OF THE INVENTION

The present invention relates to a display panel field, and more particularly to a touch liquid crystal display panel, a display device and a terminal.

### BACKGROUND OF THE INVENTION

In the field of touch display, a common electrode is generally divided into different regions, which are used to sense the touch signals of the fingers corresponding to a location of a checkerboard pattern. The partition structure of the common electrode causes the cross section to be uneven. The deformation is found by the influence of its own gravity, which easily leads to unevenness of the gap after the cell box is formed. The existence of the structural defect is likely to cause display abnormality, which leads to deterioration of display quality or even poor display.

### SUMMARY OF THE INVENTION

The technical problem to be solved by the present invention is to provide a touch liquid crystal display panel, a display device and a terminal, which can effectively avoid product display abnormality caused by uneven product gap, and improve the performance of the touch display panel without increasing the process and quality to improve product yield.

In order to solve the above technology problem, the present invention provides a touch liquid crystal display panel, comprising: a lower substrate, wherein an inner surface of the lower substrate is provided with a first common electrode region, a second common electrode region, and a spacer region located between the first common electrode region and the second common electrode region; a dielectric insulation layer covering on the first common electrode region, the second common electrode region and the spacer region; and an upper substrate opposite to the lower substrate, wherein an inner surface of the upper substrate is provided with a first spacer and a second spacer respectively, and the first spacer is pressed against the dielectric insulation layer corresponding to the first common electrode region and/or the second common electrode regions, and the second spacer is pressed against the dielectric insulation layer corresponding to the spacer region; wherein a height of the second spacer is greater than a height of the first spacer.

Wherein a height difference between the second spacer and the first spacer is set as a height of the first common electrode region or the second common electrode region.

Wherein the upper substrate and the lower substrate are parallel.

Wherein the upper substrate is a color filter substrate.

Wherein the first common electrode region and the second common electrode region are arranged in a checkerboard pattern.

In order to solve the above technology problem, the present invention also provides a display device using the above touch liquid crystal display panel. Wherein the display device includes a touch liquid crystal display panel, and the touch liquid crystal display panel comprises: a lower substrate, wherein an inner surface of the lower substrate is provided with a first common electrode region, a second common electrode region, and a spacer region located between the first common electrode region and the second common electrode region; a dielectric insulation layer covering on the first common electrode region, the second common electrode region and the spacer region; and an upper substrate opposite to the lower substrate, wherein an inner surface of the upper substrate is provided with a first spacer and a second spacer respectively, and the first spacer is pressed against the dielectric insulation layer corresponding to the first common electrode region and/or the second common electrode regions, and the second spacer is pressed against the dielectric insulation layer corresponding to the spacer region; wherein a height of the second spacer is greater than a height of the first spacer.

Wherein a height difference between the second spacer and the first spacer is set as a height of the first common electrode region or the second common electrode region.

Wherein the upper substrate and the lower substrate are parallel.

Wherein the upper substrate is a color filter substrate.

Wherein the first common electrode region and the second common electrode region are arranged in a checkerboard pattern.

In order to solve the above technology problem, the present invention also provides a terminal using the above display device, wherein the terminal has a display device, the display device includes a touch liquid crystal display panel, and the touch liquid crystal display panel comprises: a lower substrate, wherein an inner surface of the lower substrate is provided with a first common electrode region, a second common electrode region, and a spacer region located between the first common electrode region and the second common electrode region; a dielectric insulation layer covering on the first common electrode region, the second common electrode region and the spacer region; and an upper substrate opposite to the lower substrate, wherein an inner surface of the upper substrate is provided with a first spacer and a second spacer respectively, and the first spacer is pressed against the dielectric insulation layer corresponding to the first common electrode region and/or the second common electrode regions, and the second spacer is pressed against the dielectric insulation layer corresponding to the spacer region; wherein a height of the second spacer is greater than a height of the first spacer.

Wherein a height difference between the second spacer and the first spacer is set as a height of the first common electrode region or the second common electrode region.

Wherein the upper substrate and the lower substrate are parallel.

Wherein the upper substrate is a color filter substrate.

Wherein the first common electrode region and the second common electrode region are arranged in a checkerboard pattern.

The touch liquid crystal display panel, display device and terminal provided by the present invention have following beneficial effect: the first spacer is pressed against the dielectric insulation layer corresponding to the first common electrode region and/or the second common electrode regions, and the second spacer is pressed against the dielectric insulation layer corresponding to the spacer region; wherein a height of the second spacer is greater than a height of the first spacer; accordingly, the present invention can effectively avoid product display abnormalities caused by uneven product gaps, improve the performance and quality of touch display panels, and improve product yield without increasing the process.

### BRIEF DESCRIPTION OF THE DRAWINGS

In order to more clearly illustrate the embodiments of the present invention or the technical solutions in the prior art, the drawings used in the embodiments or the prior art description will be briefly introduced below. Obviously, the drawings in the following description are only some embodiments of the present invention. For those of ordinary skill in the art, without creative labor, other drawings can also be obtained from these figures.

FIG. 1 is a schematic structural view of a touch liquid crystal display panel of the present invention.

### DETAILED DESCRIPTION OF PREFERRED EMBODIMENTS

The technical solutions in the embodiments of the present invention are clearly and completely described in the following with reference to the accompanying drawings in the embodiments of the present invention. Obviously, the described embodiments are only a part of the embodiments of the present invention, and not all of the embodiments. Based on an embodiment of the present invention, all other embodiments obtained by those skilled in the art without creative efforts are within the scope of protection of the present invention.

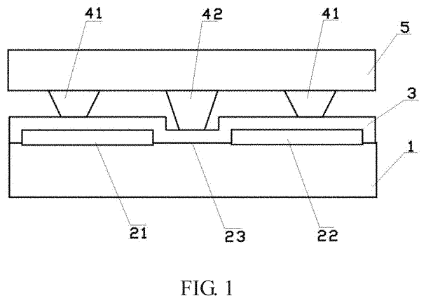

As shown in FIG. 1, FIG. 1 is a first embodiment of the touch liquid crystal display panel of the present invention.

The touch liquid crystal display panel in this embodiment includes: a lower substrate 1, wherein an inner surface of the lower substrate 1 is provided with a first common electrode region 21, a second common electrode region 22, and a spacer region 23; wherein the first common electrode region 21 and the second common electrode region 22 are arranged as a checkerboard pattern, and the first common electrode region 21 and the second common electrode region 22 arranged in the above structure can respectively generate electrode touch signal corresponding to pixels of each row of the array substrate through corresponding driving components. The spacer region 23 is a region between the first common electrode region 21 and the second common electrode region 22;

a dielectric insulation layer 3 covering on the first common electrode region 21, the second common electrode region 22, and the entire spacer region 23; and

an upper substrate 5 opposite to the lower substrate 1, wherein an inner surface of the upper substrate 5 is provided with a first spacer 41 and a second spacer 42 respectively, and the first spacer 41 is pressed against the dielectric insulation layer 3 corresponding to the first common electrode region 21 and/or the second common electrode regions 22, and the second spacer 42 is pressed against the dielectric insulation layer 3 corresponding to the spacer region 23.

Wherein, a height of the second spacer 42 is greater than a height of the first spacer 41. A position of a surface of the lower substrate 1 corresponding to any position of the upper substrate 5 means that any of the position that is vertically projected on the surface of the lower substrate 1.

In a specific implementation, the touch liquid crystal display panel further includes: a liquid crystal layer (not shown) clamped between the upper substrate 5 and the lower substrate 1, and a polarizing films respectively attached to the outer surfaces of the upper substrate 5 and the lower substrate 1. The upper substrate 5 in this embodiment is a color filter substrate, and the upper substrate 5 and the lower substrate 1 form a cell gap by connection or compression.

Furthermore, the first common electrode region 21 and the second common electrode region 22 are respectively disposed on the inner side surface of the lower substrate 1, and the first common electrode region 21 and the second common electrode region 22 are arranged as a checkerboard pattern. The heights of the first common electrode region 21 and the second common electrode region 22 are set to be the same, and the insulation region between the first common electrode region 21 and the second common electrode region 22 is the spacer region 23.

The dielectric insulation layer 3 covers the first common electrode region 21 and the second common electrode region 22, and is filled in the spacer region 23. Since the first common electrode region 21 and the second common electrode region 22 have a certain height, the dielectric insulation layer 3 is not flat, and a groove appears at the position of the spacer region 23.

Furthermore, the inner surface of the upper substrate 5 is respectively provided with a first spacer 41 and a second spacer 42, wherein the first spacer 41 is pressed against the dielectric insulation layer 3 corresponding to the first common electrode region 21 and the second common electrode region 22, the number of the first spacers 41 is multiple, and the multiple first spacers 41 form an array. The second spacer 42 is pressed against the dielectric insulation layer 3 corresponding to the spacer region 23, the number of the second spacer 42 is set to be multiple, and the multiple second spacers 42 form an array.

Preferably, the height of the second spacer 42 is greater than the height of the first spacer 41, so that the heights between any position of the upper substrate 5 and the surface of the lower substrate 1 corresponding the any position is uniform. In a specific implementation, the first spacers 41 arranged in an array are adapted to be connected to the dielectric insulation layer 3 corresponding to the first common electrode region 21 and the second common electrode region 22, and the second spacers 42 arranged in an array are adapted to be connected to the dielectric insulation layer 3 corresponding to the spacer region 23 to form a thickness of the liquid crystal cell. Due to the difference in height between the second spacer 42 and the first spacer 41, a height difference between the second spacer 42 and the first spacer 41 is set as a height of the first common electrode region 21 or the second common electrode region 22, so that the cell thicknesses at the center position and the both ends of the display panel are uniform. That is, the upper substrate 5 and the lower substrate 1 are kept in a relatively parallel state, which contributes to the improvement of the yield of the product.

The present invention also discloses a display device. In a specific implementation, the display device includes the touch liquid crystal display panel described above. The implementation manner is the same as that of the touch liquid crystal display panel, and details are not described herein.

The present invention also discloses a terminal. In a specific implementation, the terminal has a display device, and the display device includes the touch liquid crystal display panel. The implementation manner is the same as that of the touch liquid crystal display panel, and details are not described herein.

Implementing the touch liquid crystal display panel provided by the invention has following beneficial effect: the first spacer is pressed against the dielectric insulation layer corresponding to the first common electrode region and/or the second common electrode regions, and the second spacer is pressed against the dielectric insulation layer corresponding to the spacer region; wherein a height of the second spacer is greater than a height of the first spacer; accordingly, the present invention can effectively avoid product display abnormalities caused by uneven product gaps, improve the performance and quality of touch display panels, and improve product yield without increasing the process.

1. A touch liquid crystal display panel, comprising:
a lower substrate, wherein an inner surface of the lower substrate is provided with a first common electrode region, a second common electrode region, and a spacer region located between the first common electrode region and the second common electrode region;
a dielectric insulation layer covering on the first common electrode region, the second common electrode region and the spacer region; and
an upper substrate opposite to the lower substrate, wherein an inner surface of the upper substrate is provided with a first spacer and a second spacer respectively, and the first spacer is pressed against the dielectric insulation layer corresponding to the first common electrode region and/or the second common electrode regions, and the second spacer is pressed against the dielectric insulation layer corresponding to the spacer region;
wherein a height of the second spacer is greater than a height of the first spacer wherein the upper substrate and the lower substrate are maintained to be parallel a cell thickness at a center position of the display panel and a cell thickness at both ends of the touch liquid crystal display panel are uniform by arranging the second spacer which is higher in the spacer region and the first spacer which is lower in the first common electrode region or the second common electrode region having a height equal to a height difference between the second spacer and the first spacer.

2-3. (canceled)

4. The touch liquid crystal display panel according to claim 1, wherein the upper substrate is a color filter substrate.

5. The touch liquid crystal display panel according to claim 1, wherein the first common electrode region and the second common electrode region are arranged in a checkerboard pattern.

6. The touch liquid crystal display panel according to claim 1, wherein the first common electrode region and the second common electrode region are arranged in a checkerboard pattern.

7. A display device, wherein the display device includes a touch liquid crystal display panel, and the touch liquid crystal display panel comprises:
a lower substrate, wherein an inner surface of the lower substrate is provided with a first common electrode region, a second common electrode region, and a spacer region located between the first common electrode region and the second common electrode region;
a dielectric insulation layer covering on the first common electrode region, the second common electrode region and the spacer region; and
an upper substrate opposite to the lower substrate, wherein an inner surface of the upper substrate is provided with a first spacer and a second spacer respectively, and the first spacer is pressed against the dielectric insulation layer corresponding to the first common electrode region and/or the second common electrode regions, and the second spacer is pressed against the dielectric insulation layer corresponding to the spacer region;
wherein a height of the second spacer is greater than a height of the first spacer
wherein the upper substrate and the lower substrate are maintained to be parallel a cell thickness at a center position of the display panel and a cell thickness at both ends of the touch liquid crystal display panel are uniform by arranging the second spacer which is higher in the spacer region and the first spacer which is lower in the first common electrode region or the second common electrode region having a height equal to a height difference between the second spacer and the first spacer.

8-9. (canceled)

10. The display device according to claim 7, wherein the upper substrate is a color filter substrate.

11. The display device according to claim 7, wherein the first common electrode region and the second common electrode region are arranged in a checkerboard pattern.

12. A terminal, wherein the terminal has a display device, the display device includes a touch liquid crystal display panel, and the touch liquid crystal display panel comprises:
a lower substrate, wherein an inner surface of the lower substrate is provided with a first common electrode region, a second common electrode region, and a spacer region located between the first common electrode region and the second common electrode region;
a dielectric insulation layer covering on the first common electrode region, the second common electrode region and the spacer region; and
an upper substrate opposite to the lower substrate, wherein an inner surface of the upper substrate is provided with a first spacer and a second spacer respectively, and the first spacer is pressed against the dielectric insulation layer corresponding to the first common electrode region and/or the second common electrode regions, and the second spacer is pressed against the dielectric insulation layer corresponding to the spacer region;
wherein a height of the second spacer is greater than a height of the first spacer wherein the upper substrate and the lower substrate are maintained to be parallel a cell thickness at a center position of the display panel and a cell thickness at both ends of the touch liquid crystal display panel are uniform by arranging the second spacer which is higher in the spacer region and the first spacer which is lower in the first common electrode region or the second common electrode region having a height equal to a height difference between the second spacer and the first spacer.

13-14. (canceled)

15. The terminal according to claim 12, wherein the upper substrate is a color filter substrate.

16. The terminal according to claim 12, wherein the first common electrode region and the second common electrode region are arranged in a checkerboard pattern.
